(19) United States
(12) Patent Application Publication
(10) Pub. No.: US 2026/0369064 A1
(43) Pub. Date: Nov. 19, 2026

(54) EMPLOYEE MONITORING TOOL

(71) Applicant: i3 International Inc., Toronto (CA)

(72) Inventors: Jack Hoang, Toronto (CA); Andrew Hoang, Toronto (CA)

(73) Assignee: i3 International Inc., Toronto (CA)

(21) Appl. No.: 19/209,335

(22) Filed: May 15, 2025

(51) Int. Cl. G06V 20/52; G06V 10/74; G06V 40/10

(52) U.S. Cl. CPC G06V 20/52; G06V 10/761; G06V 40/10

(57) ABSTRACT

A system for identifying and tracking employees in a workspace including: a digital camera positioned so the camera obtains video containing images showing employees and others in the workspace; a monitor to display video and digital images; and a computer system to receive video from the camera and process the images to identify heads in the images. For each identified head, the system: identifies a head sub-image containing the head; identifies body part sub-images adjacent to the head sub-image; and, for each body part sub-image, determines whether the body part sub-image is changing over time and if so the system compares the body part sub-image to a reference image and calculates a similarity value. If the similarity value is greater than a threshold, the system designates the head sub-image to be an image of an employee's head, and then tracks the employee's head as the employee moves though the workspace.

### FIELD OF THE INVENTION

The present invention relates generally to artificial intelligence systems configured to identify and track employees in a retail establishment or other facility.

### BACKGROUND OF THE INVENTION

There are many existing systems for biometric control to track employees, such as fingerprints, Bluetooth™-enabled badges, retina scans, palm vein scans, RFID & NFC-based systems. However, those devices are physically attached to the employees. The other CCTV, AI-powered video analytics, face recognition analyzes employee movement, detects anomalies, and even recognizes individual employees for security and operational insights. However, these techniques presume the identities are employees. There are no devices to track the customers.

### SUMMARY OF THE INVENTION

The present invention is an employee coaching tool. It tracks employee engagement to increase revenue and is a valuable tool for organizations to enhance various aspects of their operations, decrease shrinkage, speed up checkout times, and create a better customer experience & positive impact. Engagement can also assist management with staffing levels by tracking peak customer traffic.

Increased revenue results because engaged employees are more likely to be motivated and focused on their tasks, improving productivity. This increased efficiency can positively impact revenue generation.

Decreased shrinkage is achieved because engaged employees tend to be more committed to their roles and the company, reducing the likelihood of internal issues such as theft or other shrinkage-related issues.

Faster checkout times result because engaged employees are generally more attentive and efficient. It can lead to quicker and smoother checkout processes, improving customer experience.

Customer experience is enhanced because engaged employees are likely to provide better customer service. Their positive attitude and commitment can improve customer interactions, increasing customer satisfaction and loyalty.

Staffing levels can be optimized by tracking employee engagement and correlating it with peak customer traffic, management can make more informed decisions about staffing levels. It ensures that the correct number of employees is available during busy periods, preventing understaffing or overstaffing issues.

Employee engagement can be measured through various methods, including surveys, feedback sessions, and performance evaluations. It's crucial for organizations to actively foster a positive work environment, provide opportunities for professional development, and recognize and reward employees for their contributions.

By investing in employee engagement, companies can create a workplace culture that benefits individual employees and contributes to the organization's overall success and growth.

The present invention provides an artificial intelligence system for identifying and tracking employees in video of a workplace (also referred to as a workspace). The system includes a digital camera, a computer monitor configured to display digital video and digital images, and a computer system configured to receive the video data from the camera. The digital camera is installed in the workspace in a location so that the camera obtains video data containing digital images showing employees and other people who are in the workplace. The computer system is configured to receive the video data from the camera and has a computer processor configured to process the images to identify candidate human heads in the images. For each of the candidate human head that is identified the computer system identifies a head sub-image in the image containing the candidate human head and then identifies a number of body part sub-images adjacent to the head sub-image. For each body part sub-image, the system determines whether the body part sub-image is changing over time to identify motion, and, if motion is identified in the body part sub-image, the system compares the body part sub-image to a reference image containing an employee body part and calculate a similarity value between the body part sub-image and the reference image. If the similarity value is greater than a pre-determined threshold, the system designates the head sub-image to be an image of an employee's head, and then tracks the employee's head as the employee moves within the workspace and displays the employee's trajectory through the workplace on the computer monitor.

The digital camera is preferably installed on a ceiling of the workspace, the digital camera has a fisheye lens looking down on the workspace.

The images collected by the digital camera may comprise pixels in a colour space comprising a plurality of colour dimensions, each pixel having a value in each of the colour dimensions. The similarity values may be computed on the pixels of the image in one of the colour dimensions. This may be done using a histogram intersection matching algorithm, the Manhattan distance between the body part sub-image and the reference image, and/or the Euclidean distance between the body part sub-image and the reference image.

Preferably, the similarity values are computed as a combination of the values computed using (a) the histogram intersection matching algorithm, (b) the Manhattan distance between the body part sub-image and the reference image, and (c) the Euclidean distance between the body part sub-image and the reference image. The similarly values may calculated as 0.25 feet*histogram intersection similarity+0.25 feet*Manhattan distance similarity+0.5 feet*Euclidean distance similarity, wherein Manhattan distance similarity=1−Manhattan distance, and Euclidean distance similarity=1−sqrt(Euclidean distance/2.0 feet).

The invention also provides a method of tracking employees performed by a computer system by processing video of a workplace, The system includes a digital camera installed in the workspace in a location so that the camera obtains video data containing digital images showing employees and other people who are in the workplace, a computer monitor configured to display digital video and digital images, wherein the computer system is configured to receive the video data from the camera. The computer system includes a computer processor and a memory storing computer instructions executable by the processor so that when the processor executes the instructions, the processor performs the steps of the method. This includes first processing the images to identify candidate human heads in the images, and for each of the candidate human head that is identified, identifying a head sub-image in the image containing the candidate human head, identifying body part sub-images adjacent to the head sub-image and then performing a number of steps for each body part sub-image. This includes determining whether body part sub-image is changing over time to identify motion; and if motion is identified in the body part sub-image, comparing the body part sub-image to a reference image containing an employee body part and calculating a similarity value between the body part sub-image and the reference image. If the similarity value is greater than a pre-determined threshold, the head sub-image is designated to be an image of an employee's head. Then the method tracks the employee's head as the employee moves within the workspace and displays the employee's trajectory through the workplace on the computer monitor. The digital camera is preferably installed on a ceiling of the workspace with the digital camera has a fisheye lens looking down on the workspace. The images collected by the digital camera may consist of pixels in a colour space comprising a plurality of colour dimensions, each pixel having a value in each of the colour dimensions. The similarity values may be computed on the pixels of the image in one of the colour dimensions. The similarity values may be computed using a histogram intersection matching algorithm. The similarity values may be computed as the Manhattan distance between the body part sub-image and the reference image. The similarity values may be computed based on the Euclidean distance between the body part sub-image and the reference image. Preferably, the similarity values are computed as a combination of the values computed using (a) the histogram intersection matching algorithm, (b) the Manhattan distance between the body part sub-image and the reference image, and (c) the Euclidean distance between the body part sub-image and the reference image. For example, the similarly values may be calculated as 0.25 feet*histogram intersection similarity+0.25 feet*Manhattan distance similarity+0.5 feet*Euclidean distance similarity, wherein Manhattan distance similarity=1−Manhattan distance, and Euclidean distance similarity=1−sqrt(Euclidean distance/2.0 feet).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1a-1d depict a portion of a digital image containing a candidate human head in the central sub-image surrounded by 8 adjacent sub-images.

FIG. 2 shows a top-down view of a workplace from a fisheye camera.

FIG. 3a is another top-down view from a fisheye camera of a workplace and showing people in the workplace. FIG. 3b is a corresponding motion image showing white motion blobs where motion is occurring.

FIG. 4 is another top-down view from a fisheye camera of a workplace annotated by results of processing video containing this image and marking three point of sale areas of the workplace.

FIGS. 5a-5d show 4 top-down views from a fisheye camera that have been annotated by the system.

FIG. 6 shows a top-down view from a fisheye camera that has been annotated by the system.

FIG. 7 shows another top-down view from a fish eye camera that has been annotated by the system to identify two point of sale areas of the workplace.

### DETAILED DESCRIPTION OF THE INVENTION

The engagement detection algorithm combines artificial intelligence (AI) detection with a matched algorithm. It uses functions different from those of prior art AI detection. It can detect objects whose colour feature is trained/learned in advance. For example, if a store owner wants to know an employee's working situation, the algorithm applies the engagement tracking AI to find the employee. It allows the users to, for example, input features of the employee such as the colour(s) of the employee's shirt. The algorithm can find the employee in the video image by identifying such features.

A novel method to measure the distances between employees is used. Two people may be considered to be engaged if the distance between them is between about 2.5 feet (0.76 meters) to about 4 feet (1.22 meters). The camera lens characteristics, height, focal, and object triangles are used to calculate the distance between the two people. An employee is considered to be intensely engaged if the employee is closer than 2.5 feet from a second person. The trajectory data of a hundred points between two people is analyzed to determine if the engagement happens.

If an employee has stayed at one location for a long time and has a distance of over 4 feet from any other people for a duration, this duration may be considered to be idle time. This may be relevant to assessing employee productivity.

The invention employs vision AI software called YOLOv5™ a product of Ultralytics Inc.

YOLOv5 can detect heads in a fisheye camera view. However, it can't detect a person well in a fisheye camera view because a person's body is deformed and looks different from different angles.

People have similar head features, so it is impossible to identify an employee based on the employee's head. We use YOLOv5 to detect heads and then find body parts based on the relationship between the body and the head. The body parts used are generally near the head.

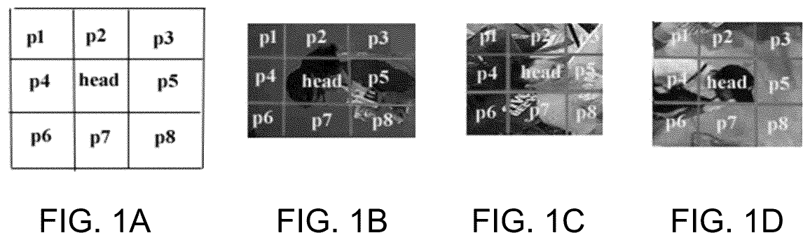

Using a fisheye camera, a person's shoulder area easier to find that in images from other cameras. We apply eight direction components around the head indicated as p1-p8 in FIGS. 1a-1d. Next, we mark the employee's shoulder or body part without a background as a template image. To determine an employee in the camera view, first, we locate eight regions around the head as the center. Some of these eight areas may include human bodies and some may just include background. Because the background is immovable and the human body moves, we filter out the background. To distinguish the background from a human body, we use an image difference method and subtract the background image from the current picture to get the human body part, then match the human body part with template images. If the human body part is sufficiently similar to template images, we conclude it is part of an employee's body, and that the person is an employee.

If the distance between a customer and an employee is less than the engagement distance threshold, the customer is deemed to be being served, and the employee is considered to be in the engagement state. Otherwise, if the distance exceeds the engagement distance threshold the customer is considered not to be being served if. If the distance from one employee to many customers is longer than the engagement distance threshold, the employee is considered not to be in the engagement state.

If an employee stays at one location, is not engaged for a more extended period, and violates the idle time threshold, the employee is considered to be in the idle state.

We combine three colour histogram matching algorithms. In a first algorithm referred to as the histogram intersection matching algorithm we calculate

$$D ( x , y ) = {\sum }_{i = 1}^{n} min ( {x}_{i} , {y}_{i} ) ,$$

where 0≤D(x,y)≤1 and xᵢ is the number of pixels in image x with value i and yᵢ is the number of pixels in image y with value i, for example in one dimension of a colour space. For example D(x,y) may be be calculated for each of dimensions red (R), green (G) and blue (B) in the RGB colour space. The larger the value of D(x,y), the more similar the two images are. If the two images are identical D(x,y)=1. To identify an employee wearing a particular uniform in image X, the distance to a reference image Y of a person wearing the uniform may be calculated. These pictures are taken from the employee's uniforms in the video. When taking pictures, it is best to choose the colour part that distinguishes the uniform from ordinary clothes. If the similarity D between X and Y is greater than a re-determined threshold in one or multiple colour dimensions (e.g. in R, G and B) then it is assumed that a person appearing in image X is an employee. Thereafter, that employee's behavior can be assessed by tracking the employee's trajectory over some time in multiple images.

A feature of the histogram intersection method is that it requires a substantial amount of computation and is sensitive to noise in the image, which often produces incorrect results. We use a second measure, referred to as the Manhattan distance calculate the matched accuracy of two images: Manhattan distance

$$D ( x , y ) = {\sum }_{i = 1}^{n} \vert {x}_{i} - {y}_{i} \vert , 0 \leq D ( x , y ) \leq 2$$

if D(x,y)=0, X is the same as Y. If D is smaller than a pre-determined threshold, that means X is similar to Y. This matching algorithm is more straightforward, but if image X is the same as Y, it can get reliable matching. For example: in image X, assume that the red ratio is 0.4, yellow ratio is 0.2, blue ratio is 0.3, white ratio is 0.1; in image Y, red ratio is 0.7, yellow ratio is 0.1, blue ratio is 0.2. The two images have similar color distribution, but their Manhattan distance 0.7, which means they are not similar, so a match based on the colour distribution is not correct. The smaller the distance, the more similar. But using the histogram intersection matching algorithm, the similarity is 0.7, which means the two images are similar, which is correct. When the colour distribution is similar but not identical, it is unstable.

The third algorithm is Euclidean distance, which is also called as L2 distance. This method is widely used to calculate the similarity of two images.

$$D ( x , y ) = \sqrt{{{\sum }_{i = 1}^{n} ( {x}_{i} - {y}_{i} ) )}^{2}} , 0 \leq D ( x , y ) \leq \sqrt{2} .$$

Euclidean distance has clear physical significance—the shorter the distance, the higher the similarity. However, Euclidean distance has an apparent defect—the measurement results do not correspond to human visual perception. Because Euclidean distance treats each colour component of the histogram feature equally in the calculation without considering the possible similarity between colours.

Because each colour histogram matching algorithm has advantages and disadvantages, we combine three algorithms to improve the accuracy of the matching algorithm. For example, we may use the following formula to combine them:

Comprehensive similarity=0.25f*histogram intersection similarity+0.25f*Manhattan distance similarity+0.5f*Euclidean distance similarity,
where

Manhattan distance similarity=1−Manhattan distance, and

Euclidean distance similarity=1−sqrt(Euclidean distance/2.0f).

Our engagement detection algorithm uses YOLOv5 to detect heads in a fisheye camera image (see, e.g., the sub-images marked as “head” in FIGS. 1b-1d). The detection accuracy will affect the algorithm accuracy. The fisheye camera is normally installed on a high ceiling, and the head in the image is tiny. Occasionally, the human head is missing from an image, and the objects on the floor, in the background, may be incorrectly detected as heads.

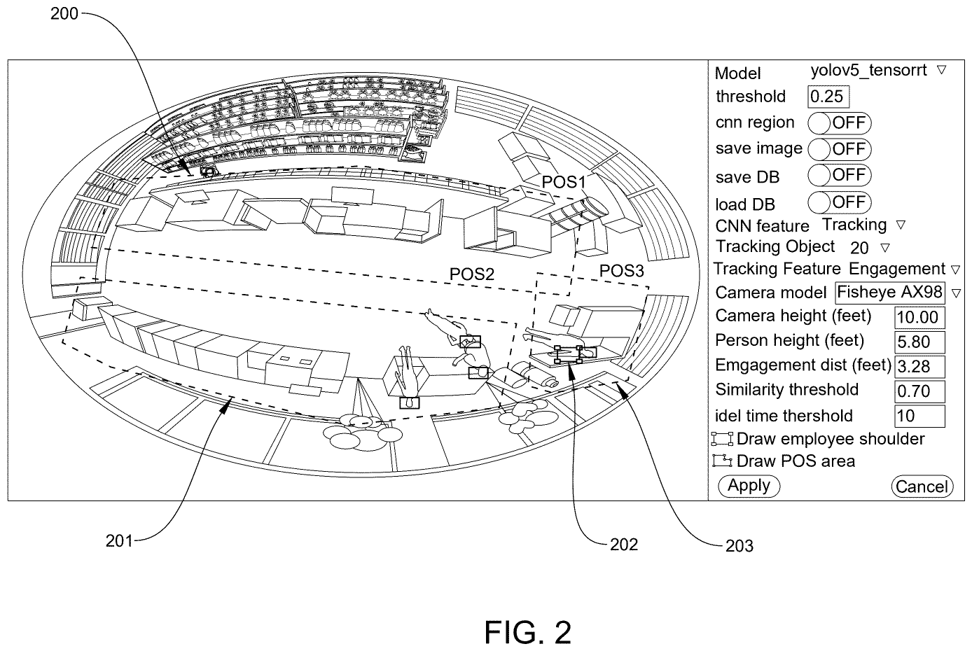

In a user interface showing a top-down view from a fish eye camera, such as shown in FIG. 2, a user clicks a “draw point of sale” (POS) area button to draw POS boundaries including the POS stations, such as POS1 200, POS2 201 and POS3 202 in FIG. 2. Then the user clicks an employee shoulder button to draw a shoulder rectangle, such as the box 202 shown in FIG. 2.

There are parameters for camera height and person height. These two parameters are used to calculate the distance between employees and customers. To match employee body parts with template images, if the matched similarity is more significant than a pre-determined similarity threshold, an employee has been identified. If the employee stays at one location without working longer than an idle time threshold, the employee is deemed to be idle.

First, we need to do motion detection to get a motion image. Motion detection is one method to detect the different pixels between the current image and the background image. The background image is the image with store background items but no people. These different pixel blobs are the moving things in the store. We define the image with different pixels as a motion image. Use the motion image to filter background rectangles around the head. Because the background does not change and the human body moves, we can filter background regions with a similar colour to the employee uniform around the heads. That can prevent some customers who are next to objects of similar color as uniforms from being mistakenly detected as store employees.

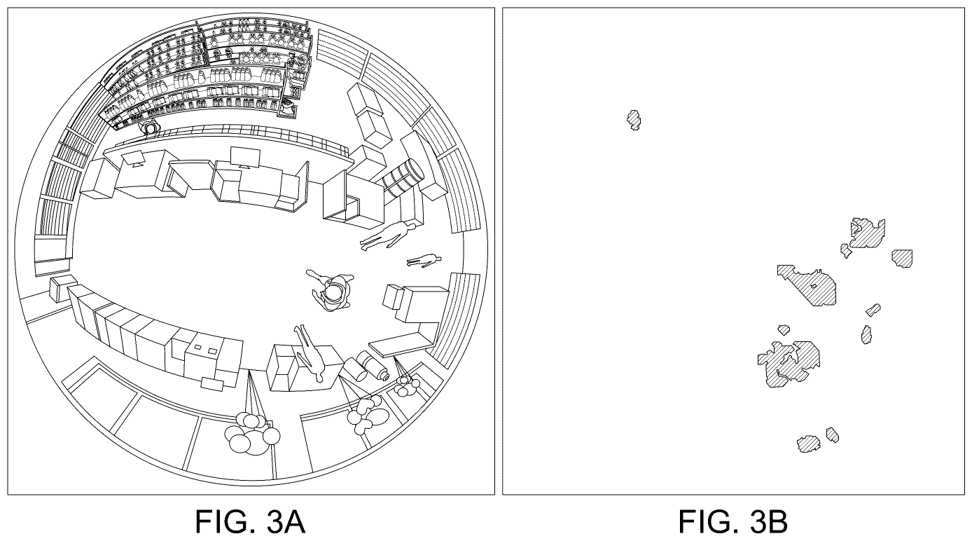

The image shown in FIG. 3a is a raw image. The image shown in FIG. 3b is a corresponding motion image. In motion images, there are white motion blobs. These motion blobs may map to persons in the corresponding raw image. If there are false persons (i.e. white blobs that do not represent people), motion images can filter out moving false persons. Some white blobs may not represent people. If these blobs are not around heads, they are not useful to us. If these blobs are around the heads, we use the regions in the raw image to match with the colour templates. If they are matched, this may cause an employee case. But this case is rare, and few background things are detected as moving objects for a long time. So we can ignore the background that is occasionally detected as white blobs.

The distance between the employee and customers in the drawing POS area must be calculated to determine whether engagement has occurred because there are some ghosts and missed detections with AI detection that will cause tracking label switches or more new label creation. Some customers may just pass by the checkout area and do not need to check out, so we consider customers who stay in the checkout area for more than, for example, 6 seconds as customers who need to check out. Customers who stay in the POS area for more than 6 seconds will be counted, and their stay time will be displayed and saved in the database. We can use the database to count the number of customers. If the distance between the customer and the employee is less than the service distance (e.g. 3.28 feet), and this state lasts for more than 3 seconds, we consider that the employee is serving the customer at this time and start recording the service time. The service time will also be displayed and saved in the database. Through the database, we can count the time the employee serves the customer.

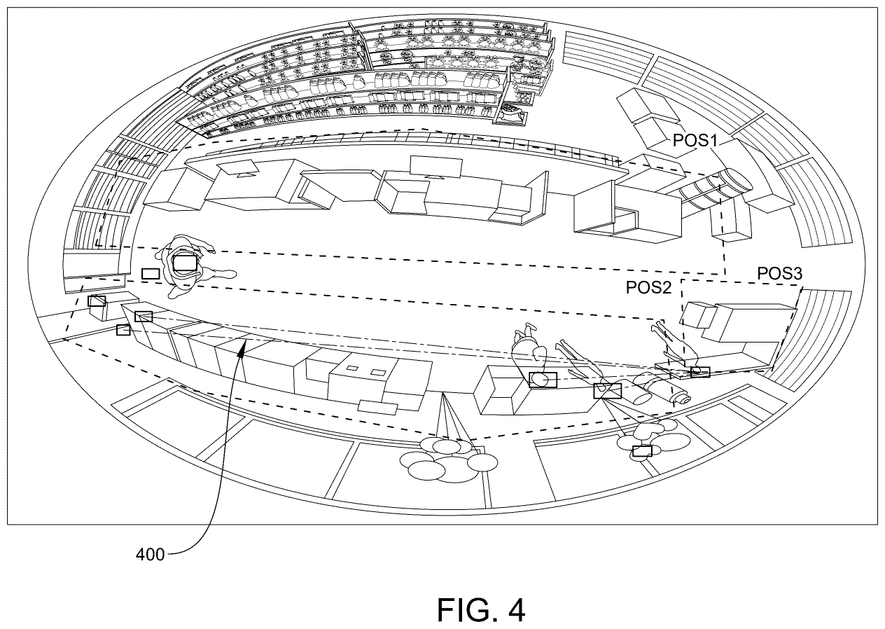

The line 400 shown in FIG. 4 is a line from the employee to the customers. The line has a distance value that is depicted near the line. It may also show the service time for the customer.

There are three database tables for engagement. Table EngagementDwell: store time duration whenever an employee engages with a customer. Each engagement event will be 1 record. This database stores time duration of each customer whenever they enter and leave the POS areas.

If the employee stays at one location longer than the idle time threshold but is not in the engagement state, the system records the idle begin and end times. The system can add up the idle time and calculate the ratio of idle time to working time, to get the employee-working ratio. The idle begin and end times may be stored to the database, such as following data.

| idle begin time | idle end time |
|---|---|
| 2023-Sep-16 13:07:22.512 | 2023-Sep-16 13:07:55.016 |
| 2023-Sep-16 13:08:11.747 | 2023-Sep-16 13:09:30.213 |
| 2023-Sep-16 13:27:54.855 | 2023-Sep-16 13:28:27.224 |

Generally, a computer, computer system, computing device, client or server, as will be well understood by a person skilled in the art, includes one or more than one electronic computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

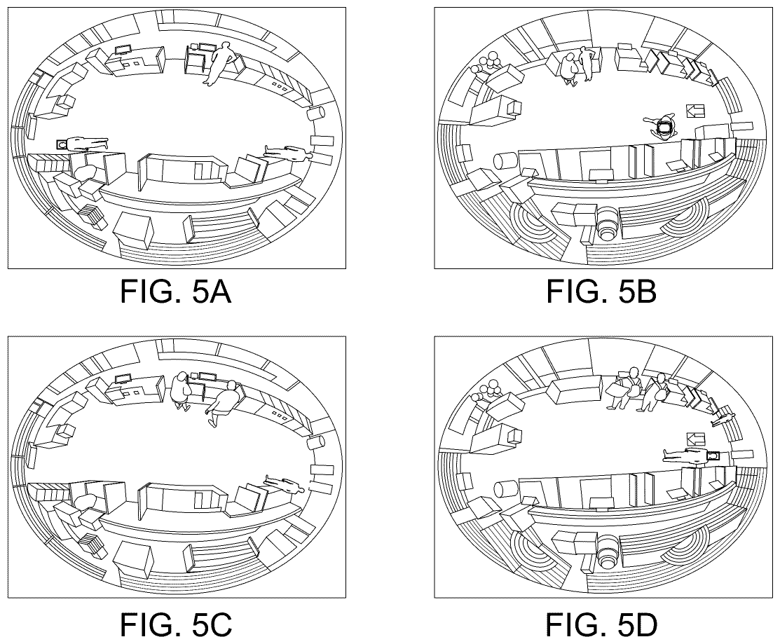

FIGS. 5a-5d show 4 top-down views from a fisheye camera that have been annotated by the system.

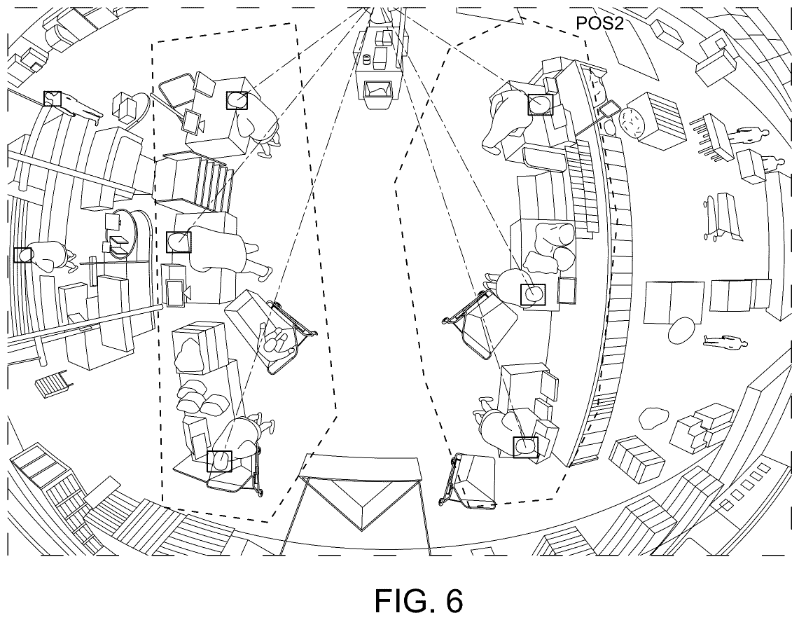

FIG. 6 shows a top-down view from a fisheye camera that has been annotated by the system.

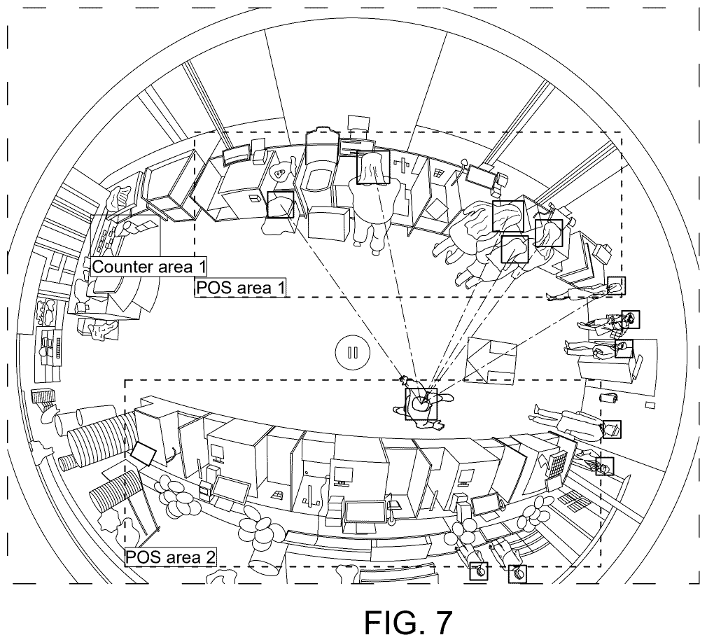

FIG. 7 shows another top-down view from a fish eye camera that has been annotated by the system to identify two point of sale areas of the workplace.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

It will be appreciated by a skilled person that, where a device is described with multiple components having different and distinct functions and functionalities, such a device further includes any different assignment of functions and functionalities between and among the components that produces a like result. It will be further appreciated that a single component, whether or not explicitly named, recited, or described, may have the functionality ascribed to different components in addition to or in lieu of the operation of those components. It will be further appreciated that the functionality of a single component may be performed by multiple other components, whether or not explicitly named, recited, or described, in addition to or in lieu of the operation of the single component.

It will be appreciated by a skilled person that, where a series of actions, options, steps, or states are described in the context of a method, such a method further includes any different order or permutation of the actions, options, steps, or states that produces a like result. It will be further appreciated that different actions, options, steps, or states of such a method may be performed simultaneously, sequentially, or otherwise.

The terms “about” and “approximately” can be used to include any numerical value that can vary without changing the basic function of that value. It is used to indicate that a specified value should not be construed as a precise or exact value, and that some variation either side of that value is contemplated and within the intended ambit of the disclosure. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Numerical values in the specification and claims of this application should be understood to include numerical values which are the same when reduced to the same number of significant figures and numerical values which differ from the stated value by less than the experimental error of conventional measurement technique of the type described in the present application to determine the value.

The scope of the claims that follow is not limited by the embodiments set forth in the description. The claims should be given the broadest purposive construction consistent with the description and figures as a whole.

What is claimed is:

1. An artificial intelligence system for identifying and tracking employees in video of a workspace, the system comprising:
a digital camera installed in the workspace in a location so that the camera obtains video data containing digital images showing employees and other people who are in the workspace;
a computer monitor configured to display digital video and digital images; and
a computer system configured to receive the video data from the camera, the computer system comprising a computer processor configured to process the images to identify candidate human heads in the images, and for each of the candidate human heads that is identified:
identify a head sub-image in the image containing the candidate human head;
identify a plurality of body part sub-images adjacent to the head sub-image;
for each body part sub-image, determine whether the body part sub-image is changing over time to identify motion, and, if motion is identified in the body part sub-image, compare the body part sub-image to a reference image containing an employee body part and calculate a similarity value between the body part sub-image and the reference image, and if the similarity value is greater than a pre-determined threshold, designate the head sub-image to be an image of an employee's head, and then track the employee's head as the employee moves within the workspace; and
display the employee's trajectory through the workspace on the computer monitor.

2. The system of claim 1, wherein the digital camera is installed on a ceiling of the workspace, the digital camera has a fisheye lens looking down on the workspace.

3. The system of claim 1, wherein the images collected by the digital camera comprise pixels in a colour space comprising a plurality of colour dimensions, each pixel having a value in each of the colour dimensions.

4. The system of claim 3, wherein the similarity values are computed on the pixels of the image in one of the colour dimensions.

5. The system of claim 4, wherein the similarity values are computed using a histogram intersection matching algorithm.

6. The system of claim 4, wherein the similarity values are computed as the Manhattan distance between the body part sub-image and the reference image.

7. The system of claim 4, wherein the similarity values are computed based on Euclidean distance between the body part sub-image and the reference image.

8. The system of claim 4, wherein the similarity values are computed as a combination of the values computed using (a) a histogram intersection matching algorithm, (b) a Manhattan distance between the body part sub-image and the reference image, and (c) Euclidean distance between the body part sub-image and the reference image.

9. The system of claim 8, the similarly values are calculated as 0.25 feet*histogram intersection similarity+0.25 feet*Manhattan distance similarity+0.5 feet*Euclidean distance similarity, wherein the Manhattan distance similarity=1−the Manhattan distance, and Euclidean distance similarity=1−sqrt(the Euclidean distance/2.0 feet).

10. A method of tracking employees performed by a computer system by processing video of a workspace, the system comprising:
a digital camera installed in the workspace in a location so that the camera obtains video data containing digital images showing employees and other people who are in the workspace;
a computer monitor configured to display digital video and digital images;
the computer system configured to receive the video data from the camera, the computer system comprising a computer processor;
and a memory storing computer instructions executable by the processor so that when the processor executes the instructions, the processor performs the steps of:
processing the images to identify candidate human heads in the images, and for each of the candidate human heads that is identified:
identifying a head sub-image in the image containing the candidate human head;
identifying a plurality of body part sub-images adjacent to the head sub-image;
for each body part sub-image:
determining whether body part sub-image is changing over time to identify motion; and
if motion is identified in the body part sub-image, comparing the body part sub-image to a reference image containing an employee body part and calculating a similarity value between the body part sub-image and the reference image; and
if the similarity value is greater than a pre-determined threshold, designate the head sub-image to be an image of an employee's head; and then
track the employee's head as the employee moves within the workspace and display the employee's trajectory through the workspace on the computer monitor.

11. The method of claim 10, wherein the digital camera is installed on a ceiling of the workspace, the digital camera has a fisheye lens looking down on the workspace.

12. The method of claim 10, wherein the images collected by the digital camera comprise pixels in a colour space comprising a plurality of colour dimensions, each pixel having a value in each of the colour dimensions.

13. The method of claim 12, wherein the similarity values are computed on the pixels of the image in one of the colour dimensions.

14. The method of claim 13, wherein the similarity values are computed using a histogram intersection matching algorithm.

15. The method of claim 13, wherein the similarity values are computed as a Manhattan distance between the body part sub-image and the reference image.

16. The method of claim 13, wherein the similarity values are computed based on Euclidean distance between the body part sub-image and the reference image.

17. The method of claim 13, wherein the similarity values are computed as a combination of the values computed using (a) a histogram intersection matching algorithm, (b) a Manhattan distance between the body part sub-image and the reference image, and (c) Euclidean distance between the body part sub-image and the reference image.

18. The method of claim 17, the similarly values are calculated as 0.25 feet*histogram intersection similarity+0.25 feet*Manhattan distance similarity+0.5 feet*Euclidean distance similarity, wherein Manhattan distance similarity=1−the Manhattan distance, and Euclidean distance similarity=1−sqrt(the Euclidean distance/2.0 feet).
